(19) United States
(12) Patent Application Publication
(10) Pub. No.: US 2026/0041273 A1
(43) Pub. Date: Feb. 12, 2026

(54) Systems And Methods For A Foldable Manual Brewing Press

(71) Applicant: Intact Idea, LLC, Irvine, CA (US)

(72) Inventors: Sergio Landau, Laguna Niguel, CA (US); Jason Weihman, Troy, MI (US)

(21) Appl. No.: 19/291,473

(22) Filed: Aug. 5, 2025

Related U.S. Application Data
(60) Provisional application No. 63/681,765, filed on Aug. 9, 2024.
(60) Provisional application No. 63/687,189, filed on Aug. 26, 2024.

(51) Int. Cl. A47J 31/38

(52) U.S. Cl. CPC A47J 31/38

(57) ABSTRACT

Disclosed herein is a foldable hand-operated beverage press including an upper post, a plurality of legs, a press plate, a lever handle rotatably coupled to the upper post, and a locking mechanism to prevent rotation of at least the upper post when in a locked state and enable rotation of at least the upper post when in an unlocked state. The upper post and the plurality of legs are rotatably coupled to the press plate. A first leg may be rotatably coupled to the upper post and locked in downward state when the locking mechanism is in the locked state. The locking mechanism includes a locking button, a spring, a coupling bar, and a washer, wherein the locking button is biased in an outward position and the washer is biased in an inward position that prevents rotation of at least the upper post.

### CROSS-REFERENCE TO RELATED APPLICATIONS

This application claims the benefit of priority to the U.S. Provisional Patent Application 63/681,765, titled, “Espresso Maker Having A Collapsible Frame, Carrying Case, and System of Use,” filed on Aug. 9, 2024, and the U.S. Provisional Patent Application 63/681,765, titled, “Systems For A Foldable, Manual Brewing Press Having A Back Post and A Front Leg and Method of Operating The Same,” filed on Aug. 26, 2024, the entire contents of both are incorporated herein by reference.

### FIELD OF THE INVENTION

Embodiments of the disclosure relate generally to devices for and methods of making beverages. In one specific embodiment, a foldable manual brewing press is disclosed that includes a plurality of components rotatably coupled together through a series of pins and includes a locking mechanism. In a particular embodiment, when the locking mechanism is unlocked the manual brewing press is configured to fold for ease of transport.

### BACKGROUND

Coffee is one of the most ubiquitous beverages in the world. There exists a wide range of coffee drinkers including causal drinkers to connoisseurs. Coffee takes many different forms throughout the world based on the ratio of ground coffee beans-to-water used during the brewing process, which typically include steeping the ground coffee beans in hot water to extract the flavor and aroma compounds. Some of the different forms of coffee include espresso, drip coffee, French press coffee, and cold brew.

One variation in the different forms of coffee includes the grind size of the coffee beans used during the brewing process. For instance, an espresso is brewed by forcing hot water through finely ground coffee beans, resulting in a concentrated form of coffee. Differently, drip coffee is brewed by placing ground coffee beans in a filter, pouring (or dripping) hot water over the ground coffee beans, and collecting the extracted liquid in a cup or carafe. In yet another method of brewing, French press coffee is brewed by steeping coarsely ground coffee beans in hot water, pressing the grounds with a plunger, and collecting pouring the remaining liquid into a cup. Cold brew is brewed in yet another distinct manner, including steeping coarsely ground coffee beans in cold water for an extended period, e.g., multiple hours.

Many people purchase coffee brewing systems or presses for their homes and workplaces. Automatic brewing presses, especially those for brewing espresso, tend to be rather expensive and exceed many budgets. Thus, various hand operated presses, e.g., manual presses, have been developed to provide a compact and relatively inexpensive alternative to high-end, automatic espresso machine or daily visits to a coffee shop. Unfortunately, many manual presses have their own drawbacks. For example, manual presses include complex mechanisms such as pumps and valves that may fail or require a degree of training for a user to properly operate. Other manual presses may be difficult to clean or fail to maintain a steady temperature during the preheating or brewing process. Accordingly, the instant disclosure seeks to overcome the above challenges by providing a manual press with a superior functionality while also being configured for manufacturing using materials that are lighter, more portable, and less expensive than manual presses currently available to consumers.

While manual espresso brewing presses currently available provide a user to pull high quality espresso while altering many variables such as bean origin, bean roast, grind size, water temperature, pressure applied and speed of brewing, etc. However, these manual pressed currently available are typically large, heavy, and overall, not portable. Thus, what is needed is a portable manual espresso brewing press capable of providing the same benefits of traditional manual espresso brewing presses. For instances, such a portable manual espresso brewing press should be intended for travel, camping, or use in small offices or living spaces. Such a manual espresso brewing press should be compact and lightweight. Such a solution is illustrated in the drawings and described in the disclosure below.

### BRIEF DESCRIPTION OF THE DRAWINGS

Illustrative examples are described in detail below with reference to the following figures:

FIG. 1 is a right back side perspective view of a foldable manual brewing press in accordance with some embodiments;

FIG. 2A is an exploded view of the right back side perspective view of the manual brewing press of FIG. 1 in accordance with some embodiments;

FIG. 2B is a perspective view of the first leg and the locking mechanism in accordance with some embodiments;

FIG. 3A is a left back side perspective view of a foldable manual brewing press illustrating one method of folding the same in accordance with some embodiments;

FIG. 3B is a right back side perspective view of a foldable manual brewing press illustrating the locking washer in an outward position resulting from depression of the unlocking button shown in FIG. 3A in accordance with some embodiments;

FIG. 3C is a right back side perspective view of a foldable manual brewing press illustrating a first stage of the folding process with the handle portion 114 folded onto handle portion 112 in accordance with some embodiments;

FIG. 3D is a right back side perspective view of a foldable manual brewing press illustrating a second stage of the folding process with a first leg folded on an upper post in accordance with some embodiments;

FIG. 3E is a right back side perspective view of a foldable manual brewing press illustrating a third stage of the folding process with a press plate folded on the upper post in accordance with some embodiments;

FIG. 3F is a right back side perspective view of a foldable manual brewing press illustrating a fourth stage of the folding process with second and third legs folded on the press plate in accordance with some embodiments;

FIG. 3G is a right back side perspective view of a foldable manual brewing press illustrating a fifth stage of the folding process with a lever handle folded on the press plate and between the second and third legs in accordance with some embodiments;

FIG. 4A is a right side perspective view of the foldable manual brewing press shown in a folded position in accordance with some embodiments;

FIG. 4B is a right side perspective view of the foldable manual brewing press shown in the folded position in accordance with some embodiments;

FIG. 5A is a right back side perspective view of the foldable manual brewing press of FIG. 1 with the lever shown in an upward position and having a portafilter and brew head positioned for use in accordance with some embodiments;

FIG. 5B is a right back side perspective view of the foldable manual brewing press of FIG. 1 with the lever shown in a downward position and having a portafilter and brew head positioned for use in accordance with some embodiments;

FIG. 6 is a cross-sectional view of the foldable manual brewing press as shown in FIG. 5B with the lever in the downward position in accordance with some embodiments;

FIG. 7A is a perspective view of a portafilter configured to receive an espresso capsule in accordance with some embodiments;

FIG. 7B is an exploded view of the portafilter of FIG. 7A in accordance with some embodiments; and

FIG. 7C is a bottom perspective exploded view of the portafilter of FIGS. 7A-7B in accordance with some embodiments.

### DETAILED DESCRIPTION

### I. Introduction

Embodiments disclosed herein describe a foldable hand-operated beverage press comprising: an upper post; a plurality of legs; a press plate, wherein the upper post and the plurality of legs are rotatably coupled to the press plate; a lever handle rotatably coupled to the upper post; and a locking mechanism to prevent rotation of at least the upper post when in a locked state and enable rotation of at least the upper post when in an unlocked state. The plurality of legs may comprise a first leg, a second leg, and a third leg, wherein the first is rotatably coupled to the upper post and locked in downward state when the locking mechanism is in the locked state. The second leg and the third leg may be coupled to the press plate opposite the upper post.

The locking mechanism is may be comprised of a locking button, a spring, a coupling bar, and a washer, wherein the locking button is biased in an outward position and the washer is biased in an inward position that prevents rotation of at least the upper post. In some examples, depression of the locking button causes the spring to compress and move the washer to an outward position thereby enabling rotation of at least the upper post. Further, in some instances, a first leg of the plurality of legs is rotatably coupled to the upper post and includes a first notch, wherein the press plate includes a second notch, and wherein the washer is disposed between the first notch and the second notch when in the inward position.

The lever handle may be formed of a distal handle portion and a proximal handle portion, and a rotatable bearing roller. In some instances, the press plate is configured to receive a portafilter and a brew head having a piston disposed within a chamber of the brew head, wherein movement of the lever handle from an upward position to a downward position causes the contact area to contact the piston and push the piston downward within the chamber of the brew head. When the locking mechanism is in the unlocked state, the upper post may rotate toward the press plate, the plurality of legs rotate about the upper post or the press plate resulting in a folded configuration of the upper post, the plurality of legs, and the press plate.

The disclosure also provides for a hand-operated beverage press system comprising: a foldable hand-operated beverage press including a rotatable lever handle; a portafilter configured to rest on the press plate; and a brewing head including a cylinder and a piston, wherein the cylinder is configured to couple with and rest on the portafilter, and wherein the piston is configured to be disposed within the cylinder, and wherein the bearing roller is configured to contact a top surface of the piston as the lever handle is rotated in a downward direction causing the piston to move in the downward direction within the cylinder.

In some examples, the foldable hand-operated beverage press comprises: an upper post, a plurality of legs, a press plate, wherein the upper post and the plurality of legs are rotatably coupled to the press plate, and a lever handle rotatably coupled to the upper post. The foldable hand-operated beverage press further comprises a locking mechanism to prevent rotation of at least the upper post when in a locked state and enable rotation of at least the upper post when in an unlocked state. In some examples, the plurality of legs comprises a first leg, a second leg, and a third leg, and wherein the first is rotatably coupled to the upper post and locked in downward state when the locking mechanism is in the locked state. The second leg and the third leg are coupled to the press plate opposite the upper post.

The locking mechanism is comprised of a locking button, a spring, a coupling bar, and a washer, wherein the locking button is biased in an outward position and the washer is biased in an inward position that prevents rotation of at least the upper post. In some examples, depression of the locking button causes the spring to compress and move the washer to an outward position thereby enabling rotation of at least the upper post. A first leg of the plurality of legs may be rotatably coupled to the upper post and includes a first notch, wherein the press plate includes a second notch, and wherein the washer is disposed between the first notch and the second notch when in the inward position.

In some examples, the portafilter comprises an upper component and a lower component, wherein the portafilter is configured to receive a capsule of coffee grounds, and wherein coupling of the upper component with the lower component causes piercings of the capsule in multiple locations such that a first subset of the piercings are configured to receive water and a second subset of the piercings are configured to enabling extraction of a beverage therefrom.

The portafilter may include: (i) a piercing grate in the upper component that is configured to pierce a first end of the capsule, and (ii) a piercing plate that is configured to pierce a second end of the capsule. The hand-operated beverage press system may also include a dispersion screen configured to rest between the portafilter and the brew head, wherein the portafilter is configured hold coffee grounds and the brew head is configured to hold water, and wherein upon rotation of the lever handle in a downward direction, the piston forces the hot water through the dispersion screen and through coffee grounds resulting in extraction of espresso that is forced out of an opening of a bottom side of the portafilter.

### II. Terminology

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

In this description, references to “an embodiment,” “one embodiment” or the like, mean that the particular feature, function, structure or characteristic being described is included in at least one embodiment of the technique introduced herein. Occurrences of such phrases in this specification do not necessarily all refer to the same embodiment. On the other hand, the embodiments referred to also are not necessarily mutually exclusive.

It is customary in the industry for one of ordinary skill in the art to use the terms “brew head” or “brewing head” to indicate and include a main cylinder, a piston assembly with a plunger and a stem, and a portafilter in a brewing press. However, others of ordinary skill in the art have been known to use the term “brewing head” when referring solely to the main cylinder and the plunger assembly pieces. In the latter case, the portafilter and piston stem are considered merely attachments to the brew head. As discussed herein, the term “brewing head” will be used to refer to and include a main cylinder and a piston with a plunger and a stem. The portafilter will be discussed as a separate component rather than as part of the brew head given the portafilter's separate attachment to the brewing press device.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “top,” “bottom,” “front,” “back,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

Unless defined otherwise, all technical and scientific terms used herein have the same meaning as commonly understood by those of ordinary skill in the art.

### III. General System Architecture

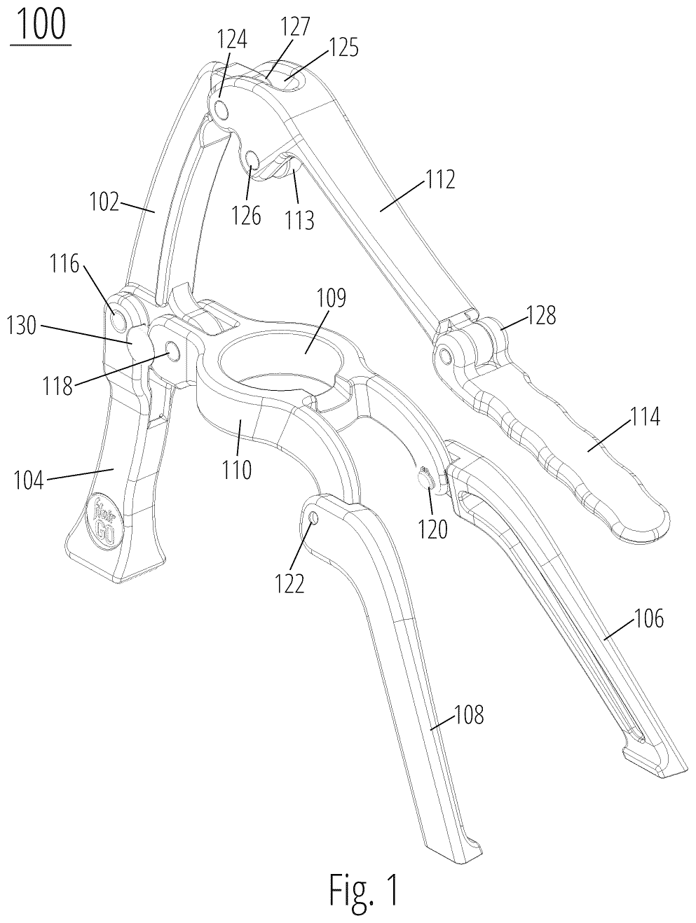

Referring now to FIG. 1, a right back side perspective view of a foldable manual brewing press is shown in accordance with some embodiments. FIG. 1 illustrates a foldable manual brewing press 100 formed of a set of components including an upper post 102, a first leg 104, a second leg 106, a third leg 108, a press plate 110, a lever handle 111 formed of a distal handle portion 112 and a proximal handle portion 114, and a rotatable contact area comprising a bearing roller 113. As will be described in detail below, the press 100 is configured to fold and unfold, thereby maximize portability. The press 100 operates to produce espresso through manual assertion of force on the lever handle 111 to depress a plunger within a brew head that forces water through espresso (ground coffee beans) within a portafilter in a similar manner as the manual brewing press of U.S. application Ser. No. 18/625,918 filed Apr. 20, 2024, the entire contents of which are incorporated herein by reference.

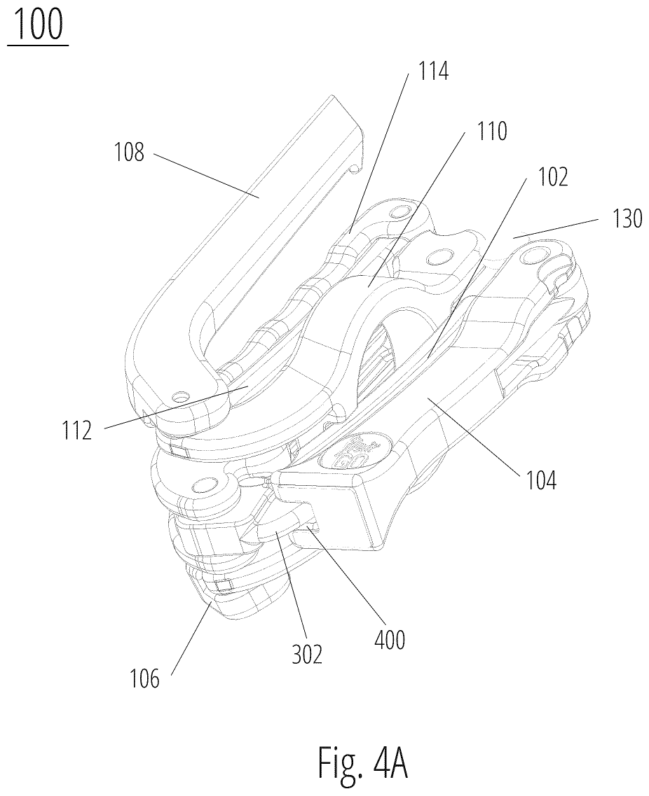

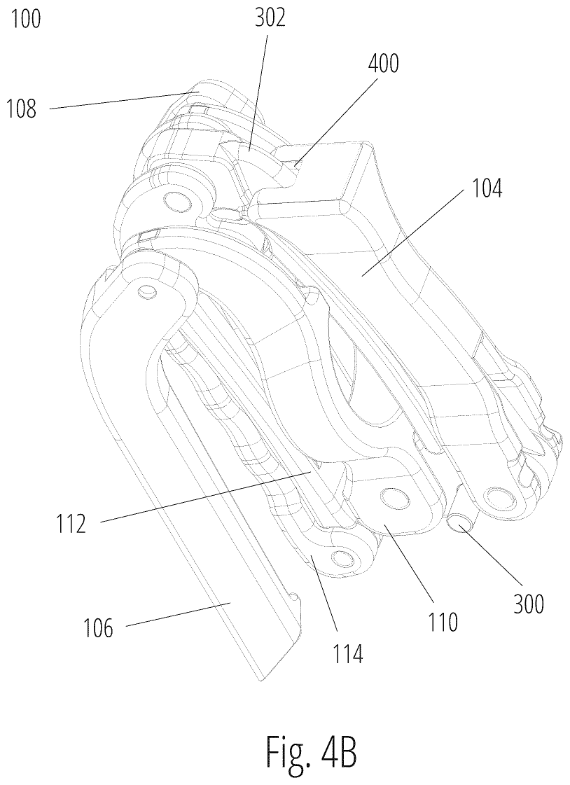

However, uniquely, the press 100 of the present disclosure is configured to fold at various, strategic positions of the overall frame of the press 100. As show in FIG. 1, the components of the press 100 are coupled via a set of pins enabling components to rotate around particular pins to convert from a first (unfolded) position as shown in FIG. 1 to a second (folded) position as shown in FIG. 4A. The set of pins includes the pin 116 that couples and around which the upper post 102 and the first leg 104 may rotate, when a locking mechanism is placed in an unlocked state (discussed below).

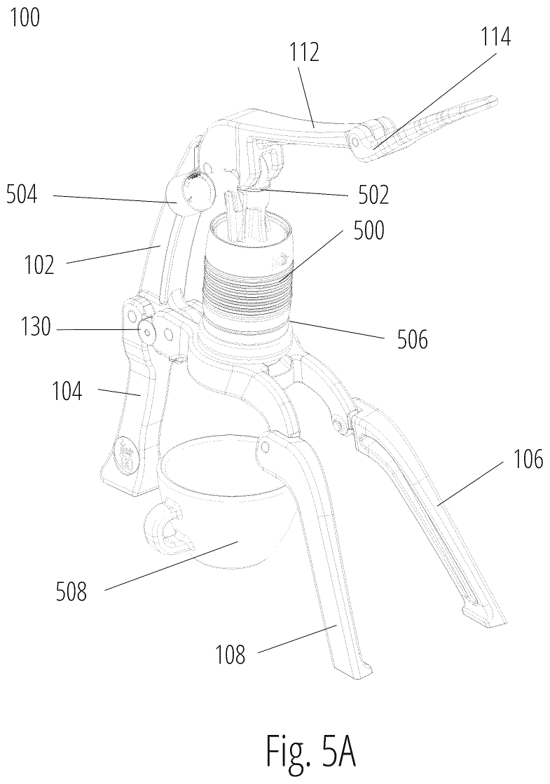

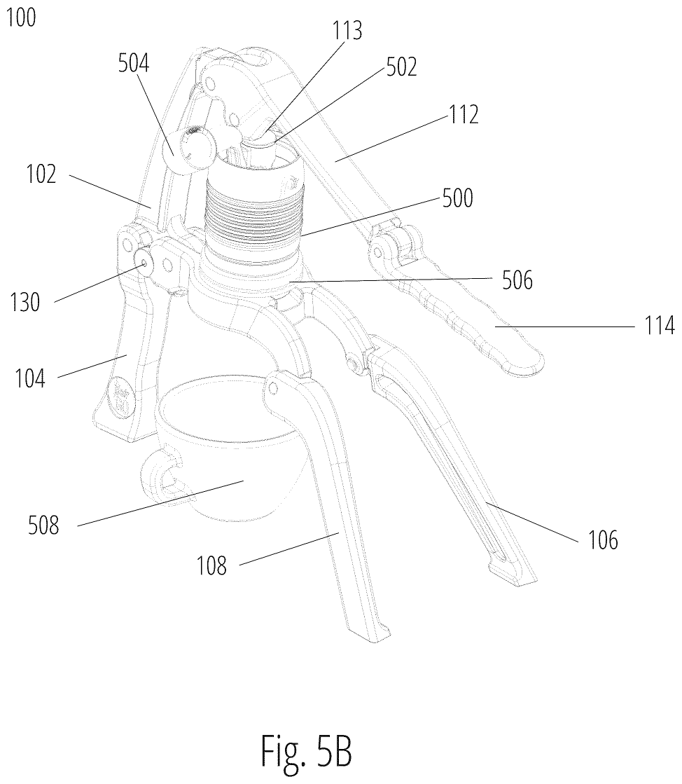

The set of pins further includes the pin 118 that couples and around which the upper post 102 and the press plate 110 may rotate, when a locking mechanism is placed in an unlocked state (discussed below). The set of pins further includes the pin 120 that couples the second leg 106 and the press plate 110. Similarly, the set of pins also includes the pin 122 that couples the third leg 108 and the press plate. The pins 120, 122 enable rotation of the second leg 106 and the third leg 108 relative to the press plate 110, respectively. The set of pins further includes the pin 124 that couples the upper post 102 and the distal handle portion 112 such that the distal handle portion 112 may rotate around the pin 124 relative to the upper post 102. The set of pins also includes the pin 126 that couples the distal handle portion 112 and the proximal handle portion 114 such that the proximal handle portion 114 may rotate around the pin 128 relative to the distal handle portion 112. Finally, the set of pins includes the pin 126 that couples the bearing roller 113 and the distal handle portion 112 such that the bearing roller 113 may rotate around the pin 126 relative to the distal handle portion 112, i.e., upon contacting a piston placed within a brew head positioned above a portafilter sitting in the aperture of the press plate 110 as shown in FIG. 5B. As will be discussed below, the bearing roller 113 is configured to contact a top surface of a piston within a brew head sitting around a portafilter that sits on or in the aperture of the press plater 110 as the lever handle is rotated in a downward direction causing the piston to move in the downward direction within the cylinder.

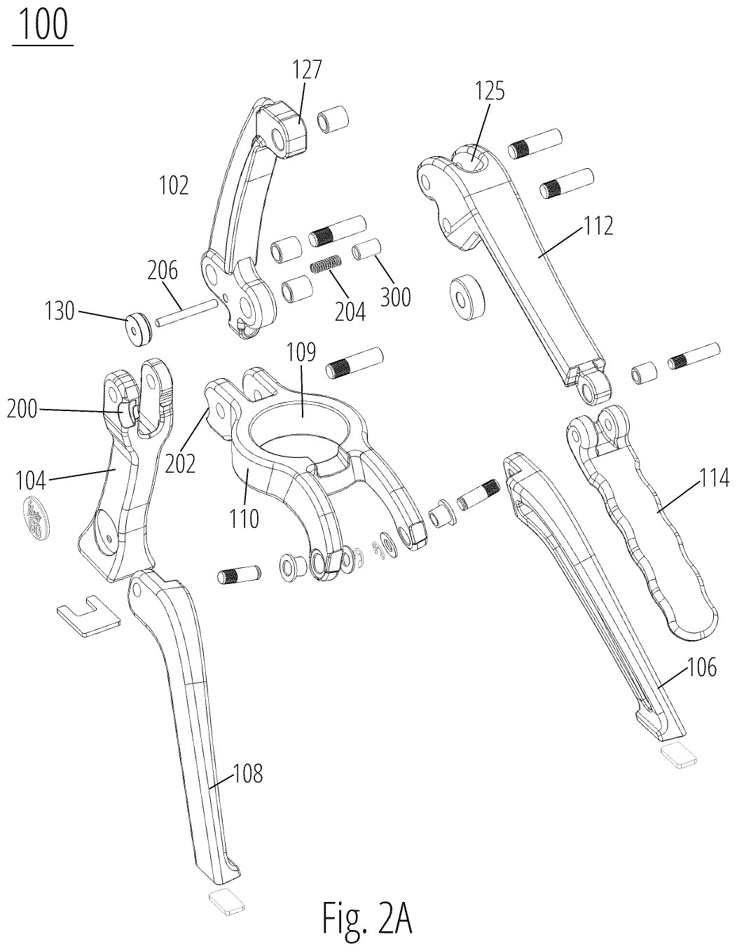

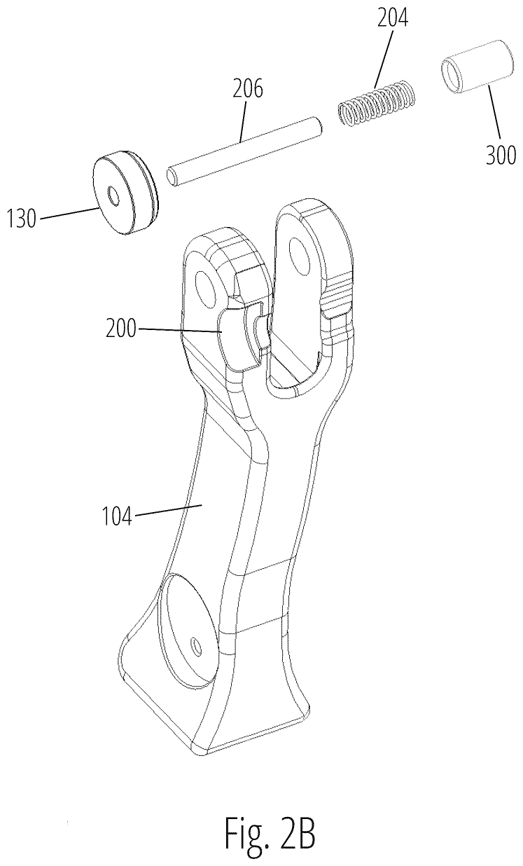

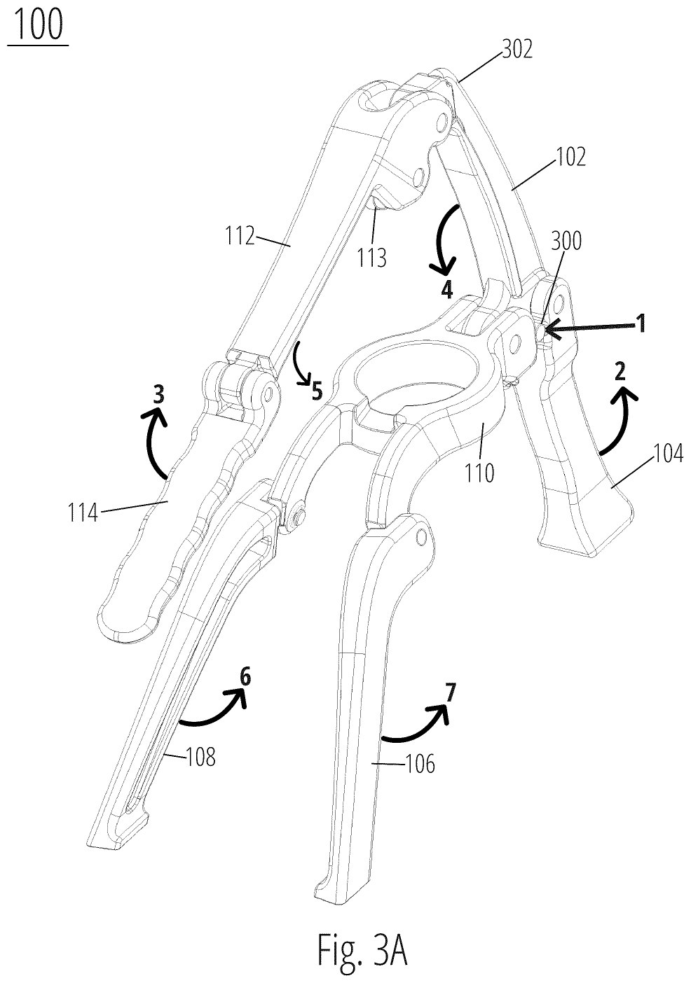

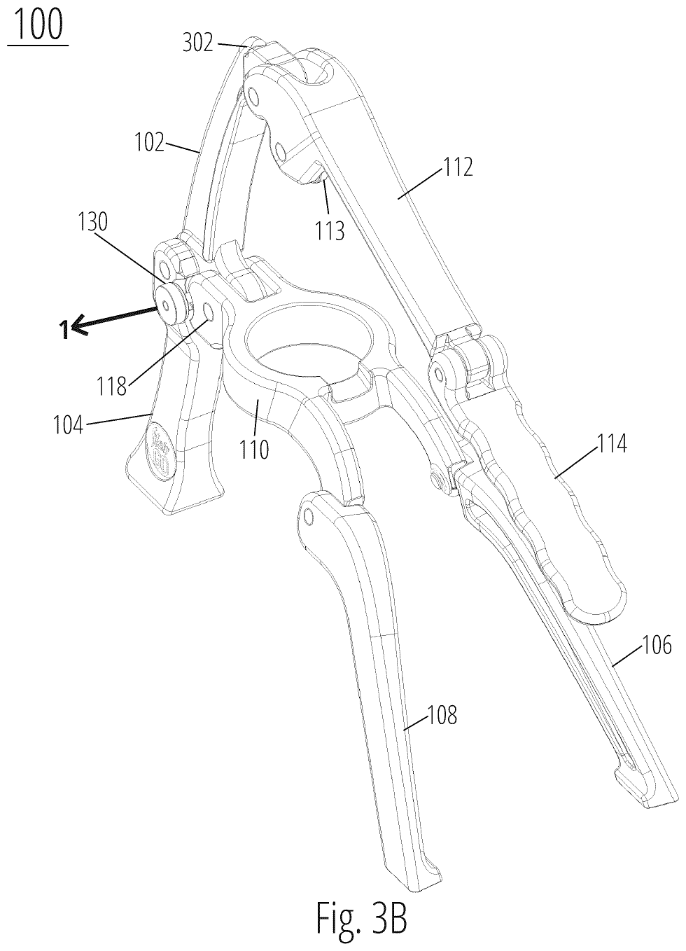

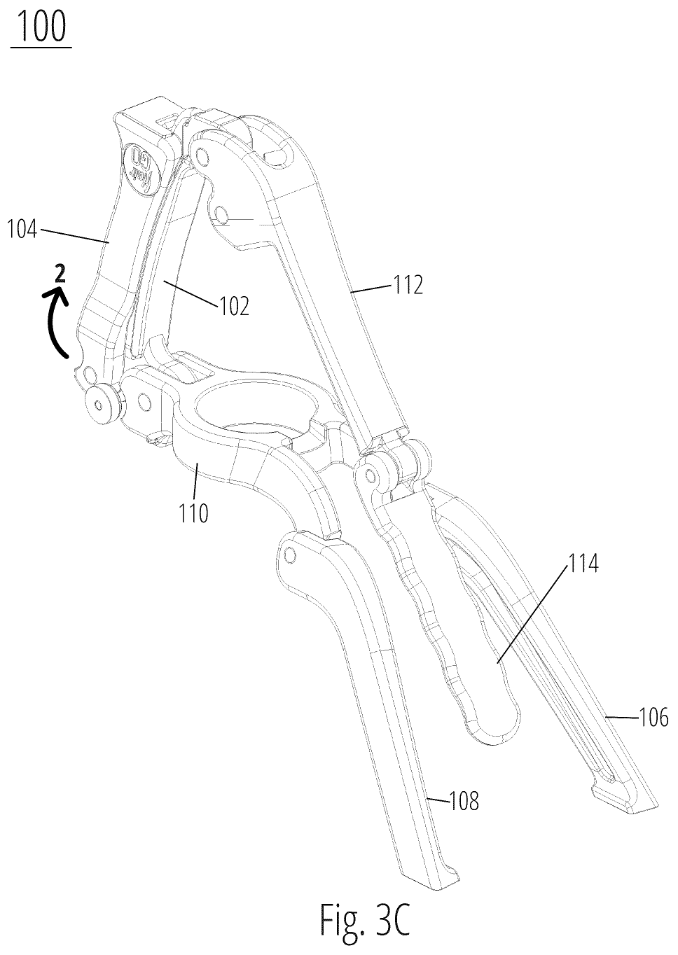

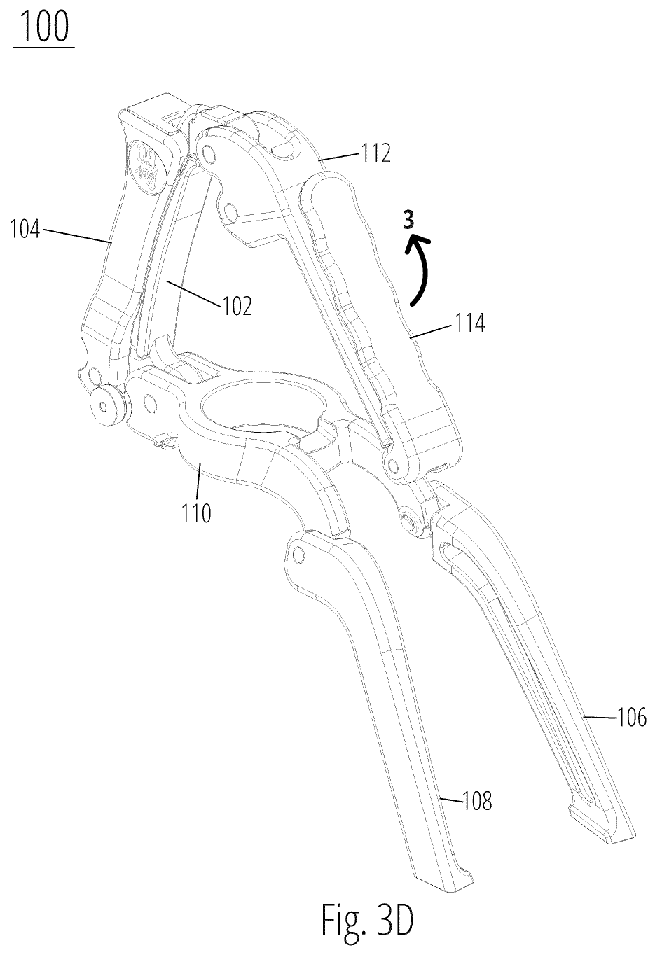

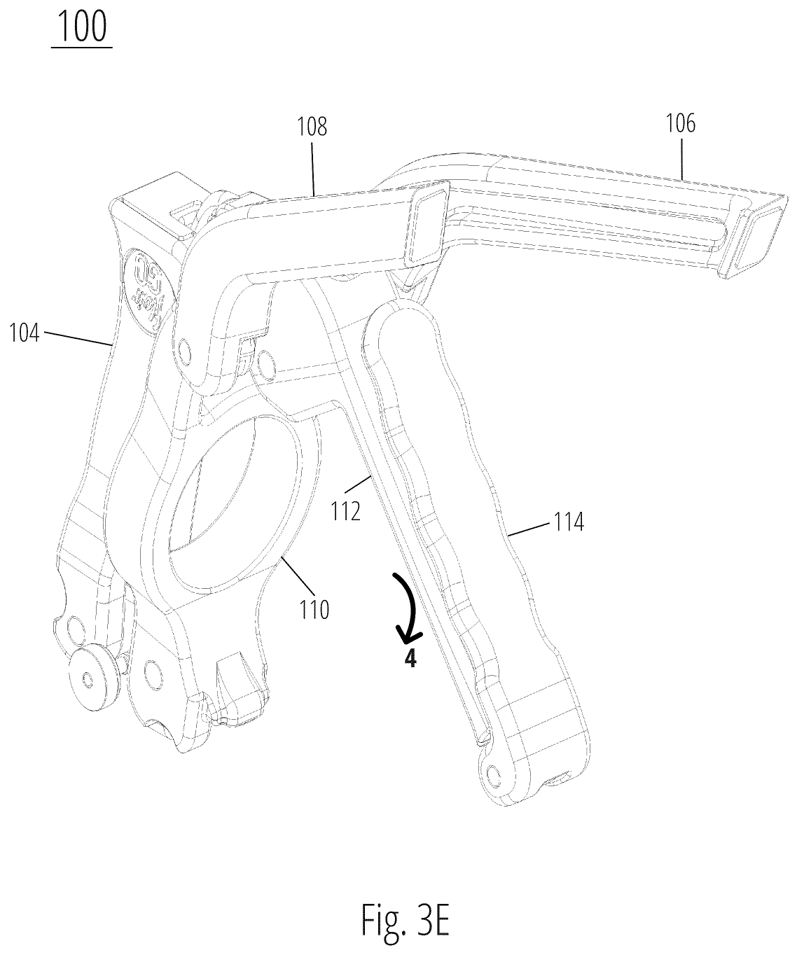

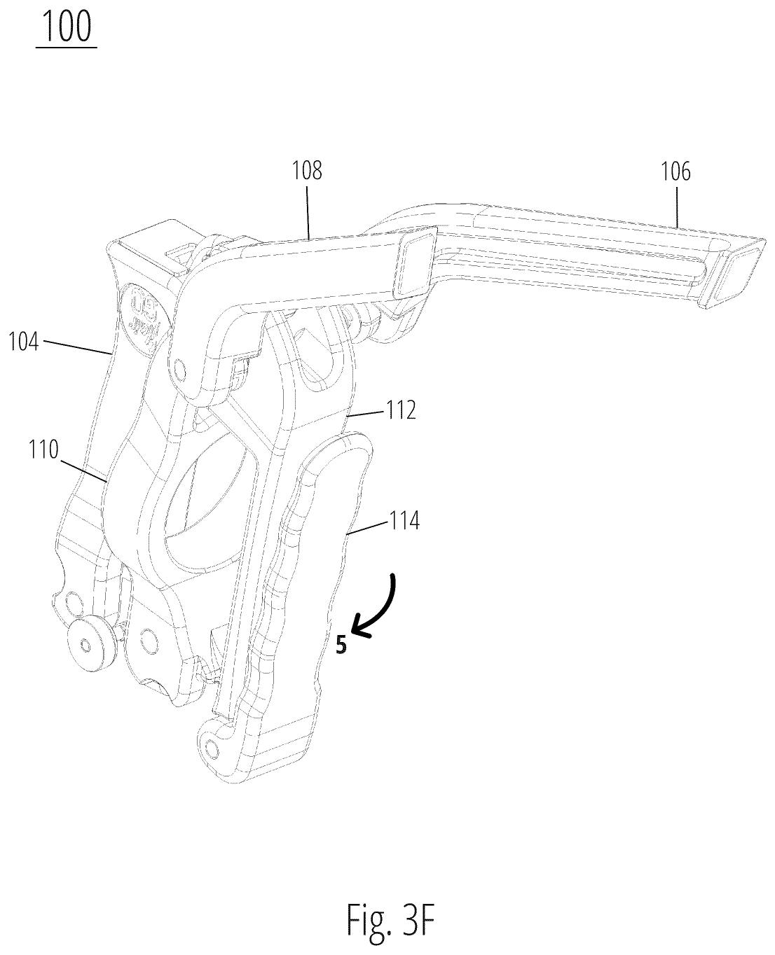

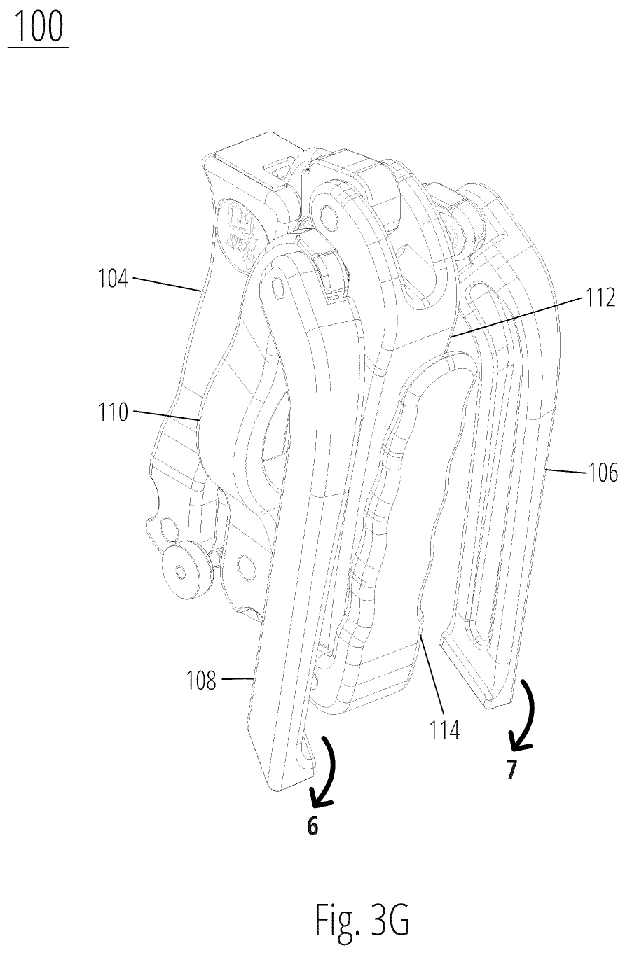

FIG. 1 also illustrates a locking washer 130, which is one component of a locking mechanism that also includes a locking button 300 (FIG. 3A) and a spring 204, where the button 300 is biased in a first (outward) state and the washer 130 is biased in a first (locked) state. As discussed below, providing inward force to the button 300 (moving the button 300 to a second (inward) position) causes the spring to compress and push the washer 300 to a second (unlocked) state. FIG. 1 illustrates the washer 130 in the first (locked) state. In particular, each of the first leg 104 and press plate 110 include notches that receive or engage the washer 300 when the locking mechanism is in a locked state, which includes the button 300 in the first (outward) state and the washer 130 in the first (locked) state. The notches are illustrated in FIG. 2 and discussed below.

The lever handle 111 is rotatably coupled to the upper post 102 via the pin 124. Specifically, a groove or notch 125 is formed in the distal end of the lever handle 111 to allow rotation of the lever handle 111 about the pin 124 and relative to a protrusion 127 at the upper end of the upper post 102. In some embodiments, numerous components of the manual brewing press 100 (or press 100) many be comprised of polycarbonate and may be manufactured through injection molding. For example, the base 102, the body 104 (including the back post 108, the front leg 110, and the press plate 112), and the lever 114 may be formed of polycarbonate, which is understood to be a thermoplastic polymer. Alternatively, the components forming the press 100 may be manufactured from aircraft-grade aluminum and stainless steel. For example, the components may be formed of aircraft-grade 6061 aluminum and milled stainless steel. Other embodiments may utilize 5052 aluminum, 7075 aluminum, or 2024 aluminum. Additionally, 430 stainless steel or 17-4 PH stainless steel may be used. It should be understood that combinations of these materials have be contemplated.

The press 100 is configured to receive a portafilter (or basket) within an opening (aperture) 109 of the press plate 110. Further, the press 100 is configured to receive a brew head atop the portafilter with a piston placed within the interior of the brew head. The brew head may be shaped as a cylinder (and referred to as a chamber) that may be formed of stainless steel and include a silicon or rubber casing about the exterior of the cylinder. The portafilter is configured to receive coffee grounds with a dispersion screen being placed on top of the portafilter. The brew head is placed atop the dispersion screen and filled with hot water. The piston is placed in the cylinder such that a proximal (top) end of the piston is adjacent to or proximate the bearing roller 113 coupled to that lever handle 111. As the lever handle 111 is moved from an upward (open) position to a downward (closed) position, the bearing roller 113 presses upon the piston pushing the piston downward into the cylinder. The piston may include one or more gaskets that creates a water-tight seal resulting in water within the cylinder being pushed downward through or against the coffee grounds within the portafilter, which produces espresso.

Specifically, the downward force of the lever handle 111 against the piston forces the water downward through the dispersion screen and against the coffee grounds within the portafilter. The dispersion screen is configured to prevent coffee grounds from moving upward into the cylinder of the brew head. The continued downward compression of the water from the downward movement of the lever handle 111 results in pulling an of espresso from an exit point of the portafilter. A cup, thermos, or other container may catch the espresso. The configuration above is illustrated in FIGS. 5A-5B.

Referring now to FIG. 2A, an exploded view of the right back side perspective view of the manual brewing press of FIG. 1 is shown in accordance with some embodiments. The exploded view of FIG. 2A provides an illustration of portions of the press 100 not shown in the assembled view of FIG. 1. In particular, the first leg notch 200 and the press plate notch 202 are shown in greater detail. Thus, from FIG. 2A, the configuration of the washer 130 being disposed within the notches 200, 202 in the first (locked) state is clear, and as a result, how the prevents rotation of the first leg 104 and the press plate 110 when the washer 130 is in the first (locked) state. Referring now to FIG. 2B, a perspective view of the first leg and the locking mechanism is shown in accordance with some embodiments. FIG. 2B illustrates that the washer 130 is configured to be sit within the notch 200 when in a first (locked) state. Specifically, the spring 204 biases the button in an outward position, which based on the coupling of the washer 130 and the button 300 through the coupling bar 206, results in biasing the washer 130 in the first (locked) state.

### IV. Illustrative Folding Methodology

Referring now to FIG. 3A, a left back side perspective view of a foldable manual brewing press illustrating one method of folding the same is shown in accordance with some embodiments. FIG. 3A illustrates a set of numerals representing one manner of folding the components forming the press 100. As noted below, the order of folding the components may vary. In FIG. 3A, the first operation indicates that the locking button 300 is depressed, which as noted above, causes movement of a locking washer 130 in an outward position to an unlocked state (shown in FIG. 3B). Depressing the locking button 300 acts to unlock rotation of the upper post 102, the first leg 104, and the press plate 110 by moving the locking washer 130 externally, which disengages the locking washer 130 from the notches of each of the upper post 102 and the first leg 104 (notches 200, 204).

Following depression of the locking button 300, a second operation denotes that the first leg 104 may be rotated in an upward direction about the pin 115 such that a slot (or groove) 400 formed in the first leg 104 receives an outward facing protrusion 302 of the upper post 102 (the slot 400 is seen in FIGS. 4A-4B).

A third operation in folding the press 100 may include folding the proximal handle portion 114 folded onto the distal handle portion 112. A fourth operation may include folding the upper post 102 (as the locking mechanism-formed of the locking button, the spring 204, and the locking washer 130-remains in the unlocked state as the locking washer 130 cannot fall back into place between the notches 200, 202 when the upper post 102 or the first leg 104 are folded) onto the press plate 110, e.g., onto a topside of the press plate 110. The folding of the lever handle 111 may then be folded around the press plate 110 and rests against (or at least adjacent to) the underside of the press plate 110, which is indicated as a fifth operation. Finally, as sixth and seventh operations (or simultaneously), the second and third legs 106, 108 are rotated toward the press plate 110, which completes the folding process.

FIG. 3B illustrates a right back side perspective view of a foldable manual brewing press illustrating the locking washer in an outward position resulting from depression of the unlocking button shown in FIG. 3A is shown in accordance with some embodiments. Specifically, FIG. 3B is provided to illustrate the locking washer 130 in the unlocked state, e.g., in an outwardly extended position.

FIGS. 3C-3G will now be discussed as illustrating a second example folding process. Specifically, the order in which some of the components forming the foldable manual brewing press 100 are folded may be altered. Thus, it should be understood that the disclosure is not intended to be limited to the example folding process illustrated in FIGS. 3C-3G. Referring now to FIG. 3C, a right back side perspective view of a foldable manual brewing press illustrating a first stage of the folding process with the proximal handle portion 114 folded onto the distal handle portion 112 is shown in accordance with some embodiments. FIG. 3C provides an illustration of a first operation of one method of folding the press 100 that includes the folding of the proximal handle portion 114 folded onto the distal handle portion 112, which for illustrative purposes, is different than the first operation discussed above with respect to FIG. 3A and demonstrates the variability in the order of folding the components forming the press 100. FIG. 3D is a right back side perspective view of a foldable manual brewing press illustrating a second stage of the folding process with a first leg folded on an upper post in accordance with some embodiments. The second operation of the folding methodology illustrated in FIG. 3D includes the rotation of the first leg 104 in an upward direction about the pin 115 such that a slot (or groove) 400 formed in the first leg 104 receives an outward facing protrusion 302 of the upper post 102. As discussed above, the operation of rotating the first leg 104, the upper post and the press plate 110 requires the depression of the locking button 300, which places the locking mechanism in an unlocked state.

FIG. 3E is a right back side perspective view of a foldable manual brewing press illustrating a third stage of the folding process with a press plate folded on the upper post in accordance with some embodiments. The third operation of the folding methodology as illustrated in FIG. 3E includes the rotation of the press plate 110 about the pin 118 toward the upper post 102. FIG. 3F is a right back side perspective view of a foldable manual brewing press illustrating a fourth stage of the folding process with second and third legs folded on the press plate in accordance with some embodiments. FIG. 3F illustrates a fourth operation of, following the rotation of the press plate 110, folding of the second and third legs 106, 108 toward the press plate 110. FIG. 3G is a right back side perspective view of a foldable manual brewing press illustrating a fifth stage of the folding process with a lever handle folded on the press plate and between the second and third legs in accordance with some embodiments. Finally, the folding methodology illustrated in FIGS. 3B-3G concludes with the illustration in FIG. 3G of a fifth operation of rotating the lever handle 111 (formed of the proximal handle portion 114 and the distal handle portion 112) between the second and third legs 106, 108.

While FIGS. 3A-3G illustrated operations for folding of the press 100, FIGS. 4A-4B illustrate the press 100 in a fully folded state. In particular, FIG. 4A illustrates a right side perspective view of the foldable manual brewing press shown in a folded position is shown in accordance with some embodiments. FIG. 4B illustrates a left side perspective view of the foldable manual brewing press shown in the folded position is shown in accordance with some embodiments. As noted above, FIGS. 4A-4B illustrates the slot 400 configured to receive the outward facing protrusion 302 of the upper post 102.

### V. Exemplary Use of the Foldable Manual Brewing Press

Referring now to FIG. 5A, a right back side perspective view of the foldable manual brewing press of FIG. 1 with the lever shown in an upward position and having a portafilter and brew head positioned for use is shown in accordance with some embodiments. The press 100 is configured to receive a portafilter 506 within the opening (aperture) 109 of the press plate 110. Further, the press 100 is configured to receive a brew head 500 atop the portafilter 506 with a piston 502 placed within the interior of the brew head 500. The brew head 500 may be shaped as a cylinder (and referred to as a chamber) that may be formed of stainless steel and include a silicon or rubber casing about the exterior of the cylinder. The portafilter 506 is configured to receive coffee grounds with a dispersion screen (not shown) being placed on top of the portafilter 506. The brew head 500 is placed atop the dispersion screen and filled with hot water. The piston 502 is placed in the cylinder such that a proximal (top) end of the piston is adjacent to or proximate the bearing roller 113 coupled to that lever handle 111. As the lever handle 111 is moved from an upward (open) position to a downward (closed) position, the bearing roller 113 presses upon the piston 502 pushing the piston 502 downward into the cylinder. The piston 502 may include one or more gaskets that creates a water-tight seal resulting in water within the cylinder being pushed downward through or against the coffee grounds within the portafilter 506, which produces espresso. In some examples, the piston may have a gauge 504 integrated therein that measures and displays the pressure against the coffee grounds (the “puck” of coffee).

Specifically, the downward force of the lever handle 111 against the piston 502 forces the water downward through the dispersion screen and against the coffee grounds within the portafilter 506. The dispersion screen is configured to prevent coffee grounds from moving upward into the cylinder of the brew head 500. The continued downward compression of the water from the downward movement of the lever handle 111 results in pulling an of espresso from an exit point of the portafilter 506. A cup, thermos, or other container (cup 508) may catch the espresso. FIG. 5B illustrates a right back side perspective view of the foldable manual brewing press of FIG. 1 with the lever shown in a downward position and having the portafilter 506 and brew head 500 positioned for use in accordance with some embodiments.

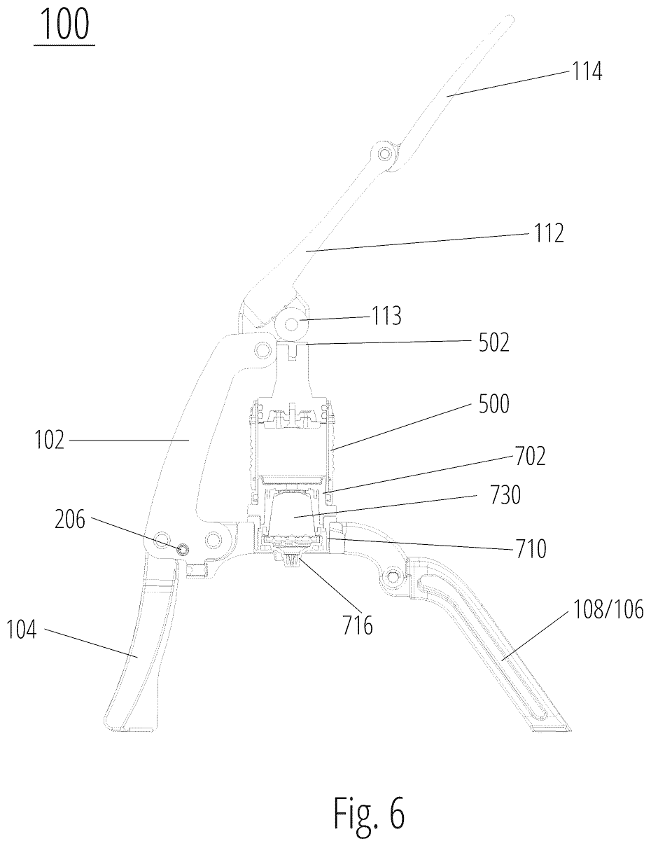

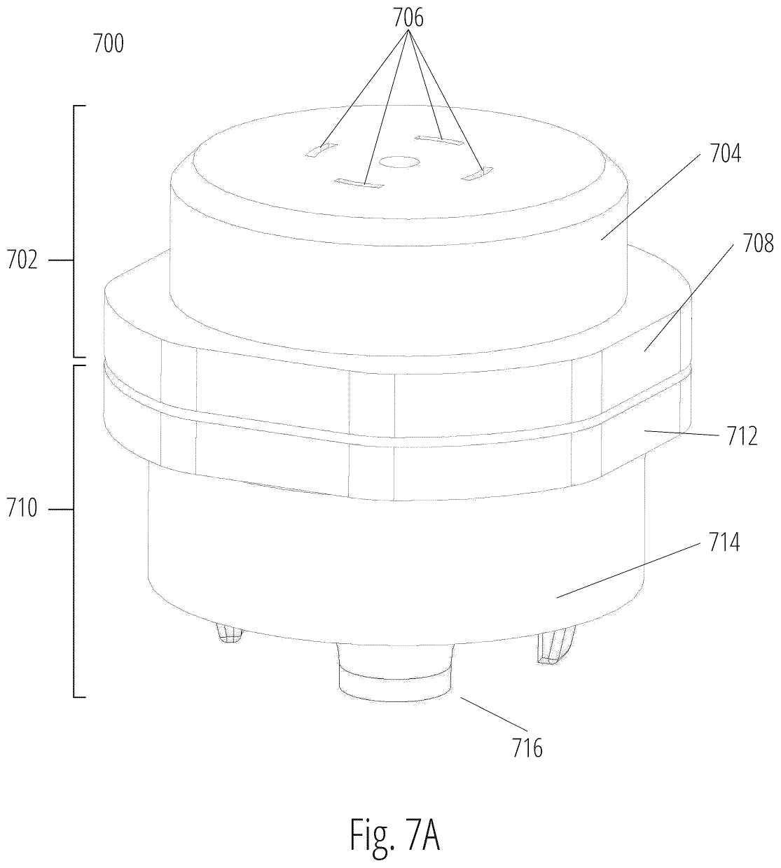

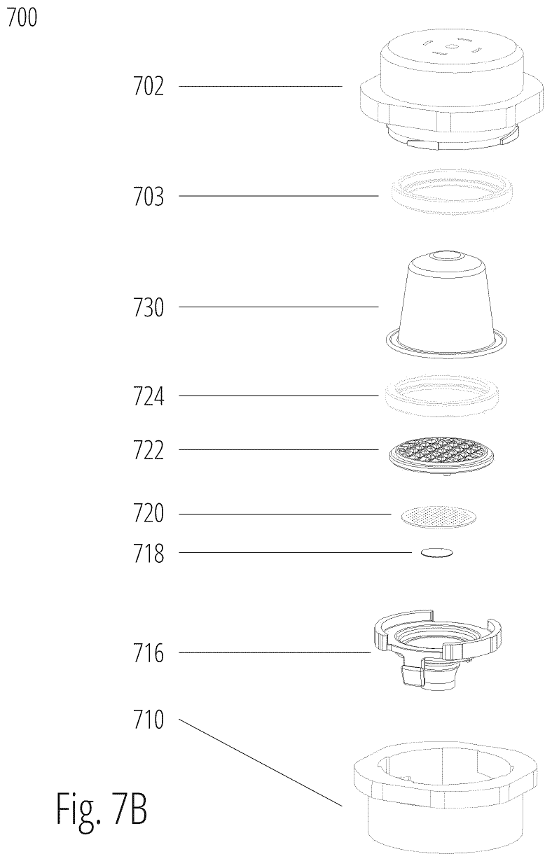

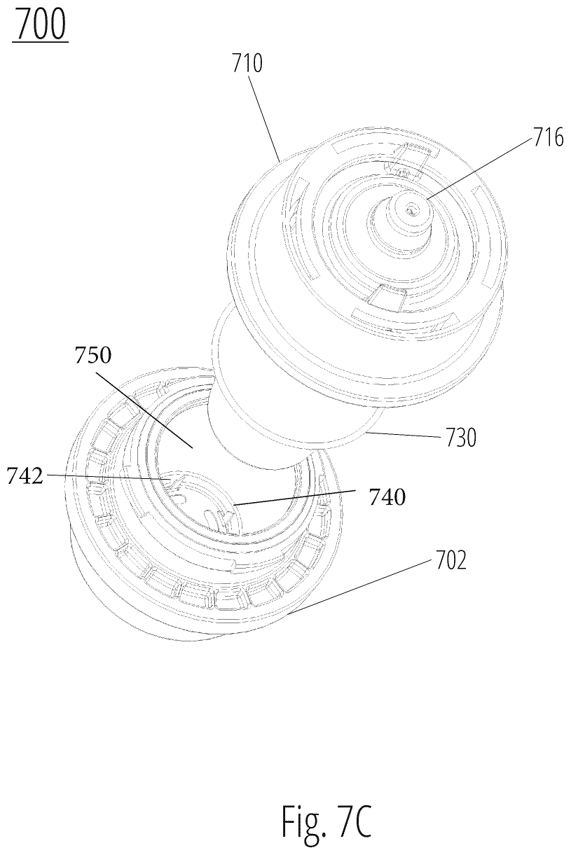

Referring to FIG. 6, a cross-sectional view of the foldable manual brewing press with the lever in the upward position is shown in accordance with some embodiments. The cross-sectional view of FIG. 6 illustrates the press 100 of FIG. 1 having a portafilter 700 placed within the opening 109 of the press plate 110. The portafilter 700 is shown in FIGS. 7A-7C and described below. Additionally, the brew head 500 is shown atop the portafilter 700 with the piston 502 placed within the brew head 500. As should be evident from the disclosure, water (typically hot) is placed in the interior chamber of the brew head 500. As the lever handle 114 is pressed downward, the bearing roller 113 presses down on the head of the piston 502, which forces the water through the capsule 730, and out of the bottom of the portafilter 700 as espresso. While FIG. 6 illustrates the use of the portafilter 700, other portafilters may be utilized instead such as those shown and described in U.S. application Ser. No. 18/625,918 filed Apr. 20, 2024, the entire contents of which were incorporated by reference above.

### VI. Capsule Portafilter

Referring to FIG. 7A, a perspective view of a portafilter configured to receive an espresso capsule is shown in accordance with some embodiments. FIG. 7A illustrates an example embodiment of the portafilter shown in FIGS. 5A-5B and alternative to that shown in FIG. 6. Specifically, the portafilter (capsule portafilter) 700 is comprised of an upper component 702 and a lower component 710 that are configured to couple together, e.g., via a threaded coupling, as may be understood through the illustrations of FIG. 7B-7C. The capsule portafilter 700 is configured to receive a pre-manufactured capsule of coffee grounds (capsule 730). The upper component 702 may be formed of an upper housing 704 and a coupling rim 708. The upper housing 704 includes a plurality of openings 706 through which water is forced from within the cylinder of the brew head 500 as the piston is pressed down as a result of lever handle 111 being moved from the open (up) position to the closed (down) position. The lower component 704 may be formed of a coupling rim 712 and a lower housing 714. The lower housing may have an opening 750 on the underside (e.g., side configured to point toward a cup) such that the pulled espresso may exit the portafilter 700 and deposit into a cup.

Referring to now FIG. 7B, an exploded view of the portafilter of FIG. 7A is shown in accordance with some embodiments. The portafilter 700 may comprise an assembly of components that are housed at least partially within the upper component 702 and the lower component 710. In particular, a first gasket 703 may be positioned within a cavity of the upper component 702 and a second gasket 724 may be positioned atop a foil piercing plate 722 that is positioned above a dispersion screen that is positioned above a spout plate 718, which are all configured to be disposed within an internal base 716. As should be understood, the gaskets 703, 724 create a water-tight seal to ensure the water is pushed through the capsule 730 and the resultant espresso is pushed through the piercing plate 722, the dispersion plate 720, and the hole of the spout plate 718.

As FIG. 7B illustrates, the portafilter 700 is opened by de-coupling the upper component 702 from the lower component 710, e.g., by a twisting motion. A capsule 730 is then placed in the cavity of the upper component 702 with the foil pointing downward toward the lower component 710 and the backside of the capsule within the cavity of the upper component 702, which contains a piercing grate 740 comprised of one or more piercing components 742 configured to pierce the backside of the capsule 730 when the portafilter 700 is closed again. The piercing grate 740 is shown in FIG. 7C.

In order to close the portafilter 700, the lower component 710 is coupled with the upper component 702. When the two components are threadably coupled (as opposed to a force fit as an alternative), the twisting motion to thread the upper and lower components 702, 710 together causes the piercing grate 740 to pierce the backside of the capsule 730 while the piercing components (e.g., a set of triangular or pyramid shaped objects) disposed on the piercing plate 722 pierce the foil of the capsule 730. The portafilter 700—including the capsule 730—may then be placed in the aperture 109 of the press plate 110 of the press 100 as discussed above. The brew head 500 may then be placed on top of the portafilter 700 such moving the lever handle 111 from the open (up) position to the closed (down) position will cause the bearing roller 113 to press downward on the piston 502, which as discussed above, forces water within the cylinder of the brew head 500 downward into the portafilter 700.

As the lever handle 111 is pressed downward, the water enters the portafilter 700 via the openings 706, enters the backside of the capsule 730 through the piercing creating by the piercing grate 740, and exits the capsule 730 through the piercings created by the piecing plate 722. While pressing through the coffee grounds within the capsule 730, the water extracts compounds from the coffee grounds converting the water into espresso. Examples of such compounds include acids, sugars, caffeine, Chlorogenic acids, lipids, oils, etc. The espresso passes through the dispersion screen 720, through a small hole in the spout plate 718, and out through an opening in the lower component 710 into a cup.

Referring to FIG. 7C, a bottom perspective exploded view of the portafilter of FIGS. 7A-7B is shown in accordance with some embodiments. As noted above, the upper component 702 includes a piercing grate 740 comprised of one or more piercing components 742 configured to pierce the backside of the capsule 730 when the portafilter 700 is closed.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A foldable hand-operated beverage press comprising:
an upper post;
a plurality of legs;
a press plate, wherein the upper post and the plurality of legs are rotatably coupled to the press plate;
a lever handle rotatably coupled to the upper post; and
a locking mechanism to prevent rotation of at least the upper post when in a locked state and enable rotation of at least the upper post when in an unlocked state.

2. The foldable hand-operated beverage press of claim 1, wherein the plurality of legs comprises a first leg, a second leg, and a third leg,
wherein the first is rotatably coupled to the upper post and locked in downward state when the locking mechanism is in the locked state.

3. The foldable hand-operated beverage press of claim 2, wherein the second leg and the third leg are coupled to the press plate opposite the upper post.

4. The foldable hand-operated beverage press of claim 1, wherein the locking mechanism is comprised of a locking button, a spring, a coupling bar, and a washer, wherein the locking button is biased in an outward position and the washer is biased in an inward position that prevents rotation of at least the upper post.

5. The foldable hand-operated beverage press of claim 4, wherein depression of the locking button causes the spring to compress and move the washer to an outward position thereby enabling rotation of at least the upper post.

6. The foldable hand-operated beverage press of claim 4, wherein a first leg of the plurality of legs is rotatably coupled to the upper post and includes a first notch, wherein the press plate includes a second notch, and wherein the washer is disposed between the first notch and the second notch when in the inward position.

7. The foldable hand-operated beverage press of claim 1, wherein the lever handle is formed of a distal handle portion and a proximal handle portion, and a rotatable bearing roller.

8. The foldable hand-operated beverage press of claim 7, wherein the press plate is configured to receive a portafilter and a brew head having a piston disposed within a chamber of the brew head, wherein movement of the lever handle from an upward position to a downward position causes the contact area to contact the piston and push the piston downward within the chamber of the brew head.

9. The foldable hand-operated beverage press of claim 1, wherein, when the locking mechanism is in the unlocked state, the upper post rotates toward the press plate, the plurality of legs rotate about the upper post or the press plate resulting in a folded configuration of the upper post, the plurality of legs, and the press plate.

10. A hand-operated beverage press system comprising:
a foldable hand-operated beverage press including a rotatable lever handle;
a portafilter configured to rest on the press plate; and
a brewing head including a cylinder and a piston, wherein the cylinder is configured to couple with and rest on the portafilter, and wherein the piston is configured to be disposed within the cylinder, and
wherein the bearing roller is configured to contact a top surface of the piston as the lever handle is rotated in a downward direction causing the piston to move in the downward direction within the cylinder.

11. The hand-operated beverage press system of claim 10, wherein the foldable hand-operated beverage press comprises:
an upper post,
a plurality of legs,
a press plate, wherein the upper post and the plurality of legs are rotatably coupled to the press plate, and
a lever handle rotatably coupled to the upper post.

12. The hand-operated beverage press system of claim 11, wherein the foldable hand-operated beverage press further comprises a locking mechanism to prevent rotation of at least the upper post when in a locked state and enable rotation of at least the upper post when in an unlocked state.

13. The hand-operated beverage press system of claim 11, wherein the plurality of legs comprises a first leg, a second leg, and a third leg, and
wherein the first is rotatably coupled to the upper post and locked in downward state when the locking mechanism is in the locked state.

14. The hand-operated beverage press system of claim 13, wherein the second leg and the third leg are coupled to the press plate opposite the upper post.

15. The hand-operated beverage press system of claim 11, wherein the locking mechanism is comprised of a locking button, a spring, a coupling bar, and a washer, wherein the locking button is biased in an outward position and the washer is biased in an inward position that prevents rotation of at least the upper post.

16. The hand-operated beverage press system of claim 15, wherein depression of the locking button causes the spring to compress and move the washer to an outward position thereby enabling rotation of at least the upper post.

17. The hand-operated beverage press system of claim 15, wherein a first leg of the plurality of legs is rotatably coupled to the upper post and includes a first notch, wherein the press plate includes a second notch, and wherein the washer is disposed between the first notch and the second notch when in the inward position.

18. The hand-operated beverage press system of claim 10, wherein the portafilter comprises an upper component and a lower component, wherein the portafilter is configured to receive a capsule of coffee grounds, and wherein coupling of the upper component with the lower component causes piercings of the capsule in multiple locations such that a first subset of the piercings are configured to receive water and a second subset of the piercings are configured to enabling extraction of a beverage therefrom.

19. The hand-operated beverage press system of claim 10, wherein the portafilter includes (i) a piercing grate in the upper component that is configured to pierce a first end of the capsule, and (ii) a piercing plate that is configured to pierce a second end of the capsule.

20. The hand-operated beverage press system of claim 10 further comprising:
a dispersion screen configured to rest between the portafilter and the brew head, wherein the portafilter is configured hold coffee grounds and the brew head is configured to hold water, and wherein upon rotation of the lever handle in a downward direction, the piston forces the hot water through the dispersion screen and through coffee grounds resulting in extraction of espresso that is forced out of an opening of a bottom side of the portafilter.
